(19) United States
(12) Patent Application Publication
(10) Pub. No.: US 2021/0081573 A1
(43) Pub. Date: Mar. 18, 2021

(54) MERGED SURFACE FAST SCAN TECHNIQUE FOR GENERATING A REFERENCE EMI FINGERPRINT TO DETECT UNWANTED COMPONENTS IN ELECTRONIC SYSTEMS

(71) Applicant: Oracle International Corporation, Redwood Shores, CA (US)

(72) Inventors: Kenny C. Gross, Escondido, CA (US); Guang C. Wang, San Diego, CA (US); Michael H.S. Dayringer, Union City, CA (US); Andrew J. Lewis, Litchfield, NH (US)

(73) Assignee: Oracle International Corporation, Redwood Shores, CA (US)

(21) Appl. No.: 16/572,439

(22) Filed: Sep. 16, 2019

(51) Int. Cl. G06F 21/73; G06F 21/55

(52) U.S. Cl. CPC G06F 21/73; G06F 2221/2151; G06F 2221/034; G06F 21/552

(57) ABSTRACT

The disclosed embodiments provide a system that generates a reference EMI fingerprint to be used in detecting unwanted electronic components in a target asset. During operation, the system gathers reference EMI signals generated by a reference asset while the reference asset is executing a periodic workload, wherein the reference asset is of the same type as the target asset and is certified not to contain unwanted electronic components. Next, the system divides the reference EMI signals into a set of profiles, which comprise EMI signals for non-overlapping time intervals of a fixed size. The system then temporally aligns and merges profiles in the set of profiles to produce a reference profile. Next, the system generates the reference EMI fingerprint from the reference profile. Finally, the system compares a target EMI fingerprint for the target asset against the reference EMI fingerprint to determine whether the target asset contains unwanted electronic components.

### BACKGROUND

### Field

The disclosed embodiments generally relate to techniques for detecting unwanted electronic components in critical assets. More specifically, the disclosed embodiments relate to a merged surface fast scan technique for generating a reference electromagnetic interference (EMI) fingerprint to facilitate detecting unwanted electronic components, such as spy chips, mod chips or counterfeit electronic components, in critical assets.

### Related Art

Unwanted electronic components, such as spy chips, mod chips or counterfeit components, are causing problems in critical assets, such as computer servers and utility system components. For example, bad actors will sometimes piggyback a “spy chip” onto a regular chip, or wire a “mod chip” onto a motherboard of a critical asset to facilitate eavesdropping on operations of the critical asset. Counterfeit components also create problems because they often perform poorly, or fail within a short period of time.

Techniques have been developed to detect such unwanted components in enterprise computing systems based on electro-magnetic interference (EMI) fingerprints, which are analyzed using prognostic-surveillance techniques. (For example, see U.S. Pat. No. 8,069,480, entitled “Detecting Counterfeit Electronic Components Using EMI Telemetric Fingerprints” by inventors Kenny C. Gross, et al., filed 16 Oct. 2007, which is incorporated by reference herein.)

The above-described technique operates by first obtaining a reference EMI fingerprint (referred to as a “golden fingerprint”) from a reference asset of the same type as a target asset, which is certified not to contain unwanted electronic components. Next, the technique obtains a target EMI fingerprint from the target asset and compares the target EMI fingerprint with the golden fingerprint to determine whether the target asset contains any unwanted electronic components.

However, in many use cases it is important to keep the scanning procedure, which is used to obtain the target EMI fingerprint, as short as possible. For example, a data center may contain over 10,000 servers, so to test all of these servers in a reasonable amount of time, the scanning process for each individual server should ideally be as short as possible (e.g., under 10 minutes). Moreover, this scanning process is not likely to be performed in a laboratory setting using expensive equipment operated by data scientists. It is more likely to be performed by technicians using low-cost, rudimentary scanning equipment, such as handheld wands. Because of the short scanning times and the rudimentary scanning equipment, the gathered EMI signals are likely to be noisy, which makes it harder to accurately detect unwanted electronic components. Fortunately, it is possible to improve detection accuracy by using a relatively noise-free golden signature because comparing a relatively noise-free golden signature against a noisy fast scan signature is significantly more accurate than comparing a noisy golden signature against a noisy fast scan signature.

Hence, what is needed is a technique for producing a relatively noise-free golden EMI signature to facilitate accurate fast scanning operations on a target asset.

### SUMMARY

The disclosed embodiments provide a system that generates a reference EMI fingerprint to be used in detecting unwanted electronic components in a target asset. During operation, the system gathers reference EMI signals generated by a reference asset while the reference asset is executing a periodic workload, wherein the reference asset is of the same type as the target asset and is certified not to contain unwanted electronic components. Next, the system divides the reference EMI signals into a set of profiles, which comprise EMI signals for non-overlapping time intervals of a fixed size. The system then temporally aligns and merges profiles in the set of profiles to produce a reference profile. Next, the system generates the reference EMI fingerprint from the reference profile. Finally, the system compares a target EMI fingerprint for the target asset against the reference EMI fingerprint to determine whether the target asset contains unwanted electronic components.

In some embodiments, while temporally aligning and merging the profiles in the set of profiles to produce the reference profile, the system first initializes a first-pass reference profile to be an anchor profile in the set of profiles, and then iteratively aligns and merges successive profiles in the set of profiles into the first-pass reference profile based on a cross-correlation coefficient. Next the system further refines the first-pass reference profile to produce the reference profile. This involves first initializing the reference profile to be the first-pass reference profile, and then successively removing each profile in the set of profiles from the reference profile, except for the anchor profile that serves as an immutable time reference, and using a phase angle determined through a CPSD computation to more precisely align and remerge each removed profile into the reference profile.

In some embodiments, the system additionally refines the reference profile. During this process, the system converts timestamps for data points in the reference profile into times relative to a beginning of the anchor profile. Next, the system uses an ensemble moving average technique to smooth out data points in the reference profile. Finally, the system performs an iterative upsampling operation on data points in the reference profile to make all time intervals uniform.

In some embodiments, while generating the reference EMI fingerprint from the reference profile, the system first performs a reference Fast Fourier Transform (FFT) operation on the reference profile to transform EMI signals in the reference profile from a time-domain representation to a frequency-domain representation. Next, the system partitions an output of the reference FFT operation into a set of frequency bins. The system then constructs a reference amplitude time-series signal for each of the frequency bins in the set of frequency bins, and selects a subset of frequency bins that are associated with the highest average correlation coefficients. Finally, the system generates the reference EMI fingerprint by combining target amplitude time-series signals for each of the selected subset of frequency bins.

In some embodiments, while selecting the subset of frequency bins, the system first computes cross-correlations between pairs of amplitude time-series signals associated with pairs of the set of frequency bins. Next, the system computes an average correlation coefficient for each of the frequency bins. The system then selects a subset of frequency bins that are associated with the highest average correlation coefficients.

In some embodiments, prior to comparing the target EMI fingerprint against the reference EMI fingerprint, the system generates the target EMI fingerprint. During this process, the system first obtains the target EMI signals by monitoring EMI signals generated by the target asset while the target asset is executing the periodic workload. Next, the system generates the target EMI fingerprint from the target EMI signals.

In some embodiments, while generating the reference EMI fingerprint, the system additionally trains a multivariate state estimation technique (MSET) model based on reference time-series signals in the reference EMI fingerprint.

In some embodiments, while comparing the target EMI fingerprint against the reference EMI fingerprint, the system feeds target time-series signals from the target EMI fingerprint into the trained MSET model to produce estimated values for the target time-series signals. Next, the system performs pairwise-differencing operations between actual values and the estimated values for the target time-series signals to produce residuals. The system then performs a sequential probability ratio test (SPRT) on the residuals to produce SPRT alarms. Finally, the system determines from the SPRT alarms whether the target asset contains unwanted electronic components.

In some embodiments, the periodic workload comprises a sinusoidal workload.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 illustrates an unwanted-component detection system in accordance with the disclosed embodiments.

FIG. 2 presents a flow chart illustrating a process for detecting unwanted components in a target asset in accordance with the disclosed embodiments.

FIG. 3 presents a flow chart illustrating a process for generating a target EMI fingerprint from target EMI signals in accordance with the disclosed embodiments.

FIG. 4 presents a flow chart illustrating a process for selecting frequency bins with the highest correlation coefficients in accordance with the disclosed embodiments.

FIG. 5 presents a flow chart illustrating a process for generating a reference EMI fingerprint in accordance with the disclosed embodiments.

FIG. 6 presents a flow chart illustrating a process for comparing a target EMI fingerprint with a reference EMI fingerprint in accordance with the disclosed embodiments.

FIG. 7 presents a flow chart illustrating a process for temporally aligning and merging profiles to produce the reference profile in accordance with the disclosed embodiments.

FIG. 8 presents a flow chart illustrating a process for generating a reference EMI fingerprint from the reference profile in accordance with the disclosed embodiments.

FIG. 9 presents a graph illustrating multiple unsynchronized EMI baseline surfaces that are merged in accordance with the disclosed embodiments.

FIG. 10 presents a graph illustrating multiple EMI baseline surfaces that are first synchronized and then merged in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

The disclosed embodiments provide a new technique for generating a relatively noise free reference EMI fingerprint, which can be used to more effectively determine whether a target asset contains unwanted electronic components. This new technique provides a number of advantages. (1) It provides higher sensitivity for detecting spy chips in large, complex electronic systems, and for positively discriminating counterfeit components from authentic components. (2) It also leads to low rates of Type-I (false-positive) and Type-II (false-negative) errors while detecting spy chips and counterfeit components. (3) It also facilitates an extremely fast scanning procedure, which is advantageous for use at checkpoints in the supply chain and at ports of entry/egress, when electronic systems are transported across national boundaries to get to assembly plants, and when assembled integrated systems are transported across national boundaries for global distribution.

For example, in computer data centers, the faster scan procedure can be used while unpacking servers from the loading dock and performing an initial power-on-self-testing (POST) sequence before installing the servers into racks. The POST sequence is a convenient time to perform an EMI fingerprint scan to ensure that the servers did not receive any counterfeit parts (or spy chips) in the supply chain. Moreover, because standard POST testing can take up to an hour anyway, keeping the EMI fingerprint scan times under an hour makes it possible to perform the scans without significantly increasing the time required to initially set up the servers.

To perform EMI-fingerprint-based detection of counterfeit components and embedded spy chips, we can run a deterministic, dynamic load profile on a target asset while performing an EMI scan using: a handheld “wand” type antenna; a “mag-mount” antenna; or an insertable antenna configuration. We can then use the gathered EMI signals to create a 3D binned-frequency pattern or “fingerprint” for the target asset, which can be compared against a corresponding EMI fingerprint for a reference asset, which is also referred to as a “golden system.”

With a fast scan of time comprising a limited number of minutes for a target system, the “accuracy” of the EMI fingerprint is a function of the scanning and analysis hardware. By using large and expensive scanning hardware, we can achieve very high accuracy. However, for practical use cases, we need to keep the scanning instrumentation to under about $250 in cost. At this price point, for a scan time of, say, N=10 minutes, the accuracy of the EMI fingerprint for a test system is adequate. During the scan for the golden system EMI fingerprint, if we also conduct an N=10 minute scan, the uncertainty level is approximately the same. However, we have devised a new analytical procedure by which we can produce a substantially more accurate golden system EMI fingerprint, even using exactly the same instrumentation and analysis hardware. In this new procedure, instead of performing the golden system EMI fingerprint scan for N minutes, we conduct this scan for a longer time to create a long, repetitive deterministic dynamic EMI fingerprint. For example, for N=10 (for a desired 10-minute EMI fingerprint scan time), we start by running the scan on the golden system for slightly over an hour, which effectively creates six 10-minute profiles with short intervening “sleep times” between each profile. We then “cut up” the long one-hour scan into six dynamic load “profiles,” each of which is 10 minutes in length, with a short “flat noisy” stub on each end of the profile. These profiles are then processed as follows.

Step 1: We initialize a first-pass reference profile to be the first complete dynamic load profile. Note that this first “anchor profile” establishes a “reference time sequence” that will be immutable and unchanging throughout the remaining sequence of operations.

Step 2: We pick the second profile and slide its data forward/backward to optimize its fit (maximum cross correlation) with the first-pass reference profile. We then merge this second profile with the first-pass reference profile to generate an improved first-pass reference profile. This synchronization process involves systematically incrementing a lead/lag time by a small increment, for example one second, and computing a Pearson cross-correlation coefficient (CCC) for each increment. We then select the optimum time difference that maximizes the CCC.

Step 3: We repeat step 2 for subsequent profiles, each time merging the subsequent profile with the first-pass reference profile. With each repetition of this process for a new profile, the first-pass reference profile becomes more accurate. Note that if we simply “cut and pasted” the six profiles and merged them, we would not necessarily increase the accuracy of the EMI fingerprint, because any asynchronies in the deterministic load for the separate profiles would create destructive interference in the merged EMI fingerprint.

Step 4: After all N profiles are synchronized and merged to produce the first-pass reference profile, we further refine the first-pass reference profile to produce the final reference profile. This involves first initializing the reference profile to be the first-pass reference profile. We then perform a second pass through the profiles, except for the anchor profile that serves as a time reference. During this second pass, the data generated from each profile is removed from the reference profile. After optimizing and realigning, each removed profile is merged back into the reference profile, but now using a much more accurate synchronization technique called the cross-power spectral density (CPSD) technique. Note that CPSD is a bivariate frequency-domain technique that uses a sophisticated bivariate FFT computation that infers with high accuracy the “phase angle” (in the frequency domain) between two time series; it is possible to compute a very fine-grained estimate of the lag time from this phase angle. This second pass is performed to ensure that the effects of any abnormalities or artifacts (e.g., arising from stray ambient EMI signals during the scan process) that may have been present in the earliest profiles during the initial iterations with the CCC technique are minimized.

Step 5: We take the final reference profile and convert the timestamps from the different profiles to times (in seconds) relative to the beginning of the first profile.

Step 6: To smooth out the data in the reference profile, we now apply a moving-window ensemble average function with a width of 20 samples to the reference profile.

Step 7: We perform an iterative upsampling operation on the data produced by step 6 to make the time intervals exactly uniform. Note that step 6 produces “densified” samples, but the sampling intervals are not necessarily uniform. Step 7 maintains the high accuracy from step 6, but transforms the sampling intervals to be exactly equal. For example, step 7 can be used to set the sampling intervals to exactly one time unit, or one second.

Step 8: The output of step 7 is a final synchronized and merged profile, which can be used to produce a reference EMI fingerprint through a process, which is described in more detail below.

Note that the above-described “dual-pass” iterative approach uses an approximate (but lightweight) CCC-based technique in the first iteration, then systematically “removes” each profile, one at a time, from the reference profile, and then merges it back in using the more accurate (but more computationally costly) CPSD technique in the second pass. This produces a highly accurate golden system fingerprint, which can then be used while performing rapid scans of large numbers of test systems.

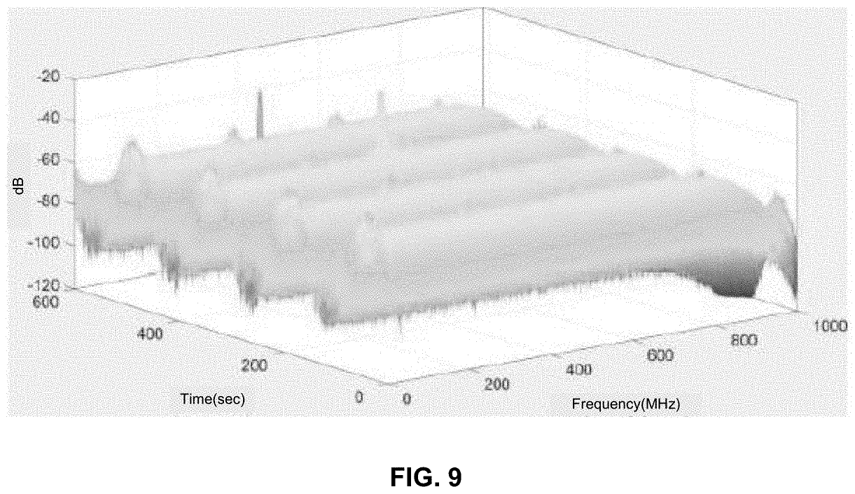

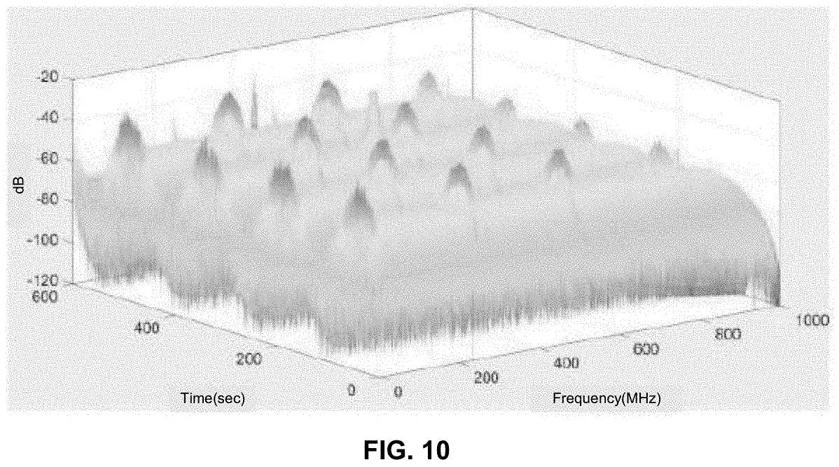

Empirical results associated with the above-described technique appear in FIGS. 9 and 10. (These empirical results were produced using a sinusoidal load profile, but the technique works with any repetitive dynamic profile.) FIG. 9 illustrates a naïve “cut-and-paste” superposition of five separate EMI fingerprint scans. Note that the deterministic content is blurry because of “destructive interference” arising from slight asynchronies in the naïve superposition. FIG. 10 illustrates a highly optimized golden system EMI fingerprint produced by the new technique described above. Note that the deterministic components are significantly enhanced and the noise content is effectively diminished in comparison to the cut-and-paste EMI fingerprint illustrated in FIG. 9.

### Unwanted-Component Detection System

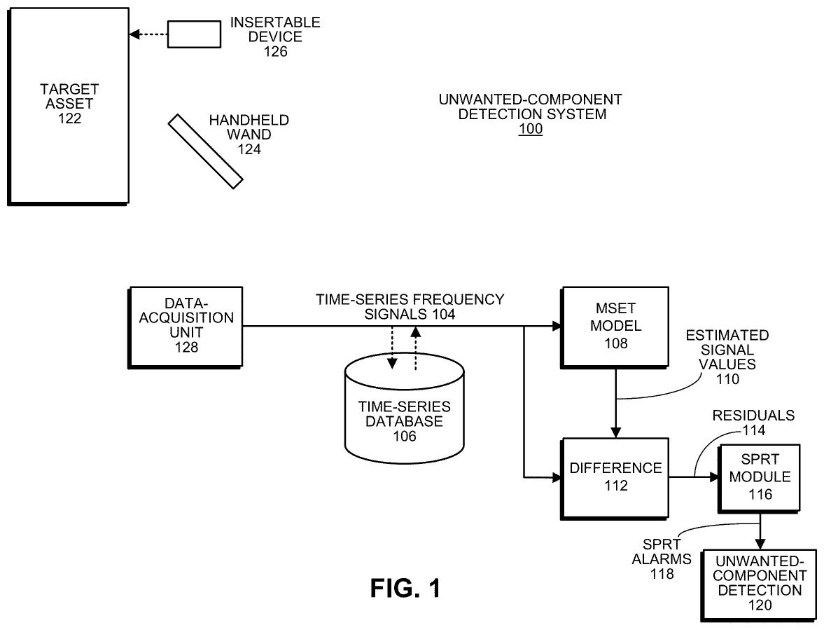

FIG. 1 illustrates an exemplary unwanted-component detection system 100 in accordance with the disclosed embodiments. As illustrated in FIG. 1, unwanted-component detection system 100 gathers EMI signals from a target asset 122. Target asset 122 can generally include any type of system that includes electrical components, such as a component in a utility electrical distribution system, a computer server, or a machine in a factory.

The EMI-signal-gathering process can involve a number of possible EMI-signal-acquisition devices, including a handheld wand 124 and an insertable device 126. Handheld wand 124 can generally include any type of handheld device that is capable of gathering EMI emissions from target asset 122 (for example, through an antenna), and transmitting associated EMI signals to data-acquisition unit 128. Insertable device 126 can generally include any type of device that can be inserted into target asset 122 to gather EMI signals. For example, insertable device 126 can include: a PCI card, which is insertable into a PCI slot in the target computing system; an HDD filler package, which is insertable into an HDD slot in the target computing system; or a USB dongle, which is insertable into a USB port in the target computing system. When insertable device 126 is inserted into target asset 122, insertable device 126 is electrically coupled to a ground plane or other signal lines of target asset 122 (or, alternatively, includes a fixed antenna structure, which is optimized for a specific frequency range) to gather EMI signals from target asset 122. The gathered EMI signals are then communicated to data-acquisition unit 128.

During operation of unwanted-component detection system 100, time-series frequency signals 104 from data-acquisition unit 128 can feed into a time-series database 106, which stores the time-series frequency signals 104 for subsequent analysis. Then, time-series frequency signals 104 either feed directly from data-acquisition unit 128 or from time-series database 106 into an MSET pattern-recognition model 108. Although it is advantageous to use MSET for pattern-recognition purposes, the disclosed embodiments can generally use any one of a generic class of pattern-recognition techniques called nonlinear, nonparametric (NLNP) regression, which includes neural networks, support vector machines (SVMs), auto-associative kernel regression (AAKR), and even simple linear regression (LR).

Next, MSET model 108 is “trained” to learn patterns of correlation among all of the time-series frequency signals 104. This training process involves a one-time, computationally intensive computation, which is performed offline with accumulated data that contains no anomalies. The pattern-recognition system is then placed into a “real-time surveillance mode,” wherein the trained MSET model 108 predicts what each signal should be, based on other correlated variables; these are the “estimated signal values” 110 illustrated in FIG. 1. Next, the system uses a difference module 112 to perform a pairwise-differencing operation between the actual signal values and the estimated signal values to produce residuals 114. The system then performs a “detection operation” on the residuals 114 by using SPRT module 116 to detect anomalies and to generate SPRT alarms 118. (For a description of the SPRT model, please see Wald, Abraham, June 1945, “Sequential Tests of Statistical Hypotheses.” Annals of Mathematical Statistics. 16 (2): 117-186.)

SPRT alarms 118 then feed into an unwanted-component detection module 120, which detects the presence of unwanted components inside target asset 122 based on the tripping frequencies of SPRT alarms 118.

### Detecting Unwanted Components

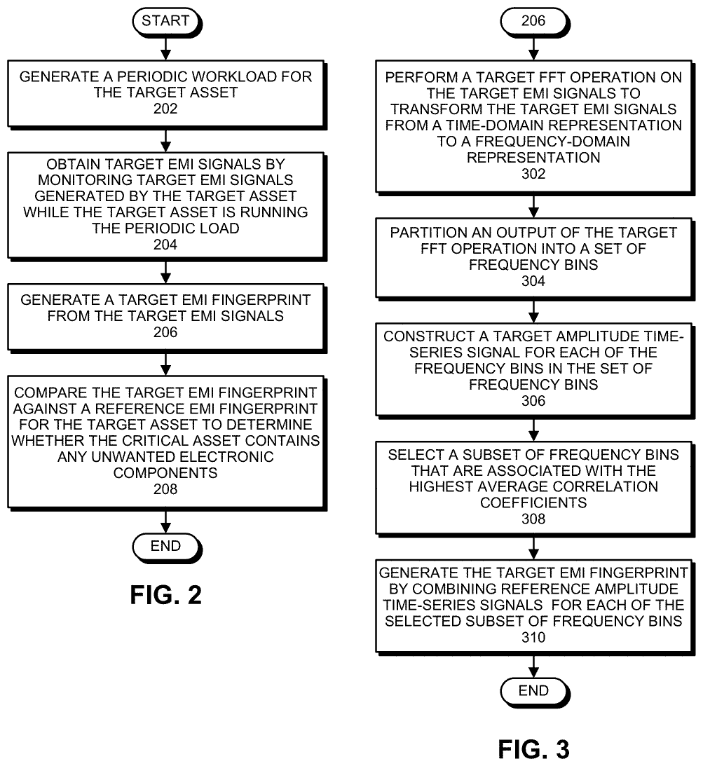

FIG. 2 presents a flow chart illustrating a process for detecting unwanted electronic components in a target asset in accordance with the disclosed embodiments. First, the system generates a periodic workload for the target asset (step 202). Next, the system obtains target EMI signals by monitoring EMI signals generated by the target asset while the target asset is running the periodic workload (step 204). The system then generates a target EMI fingerprint from the target EMI signals (step 206). Finally, the system compares the target EMI fingerprint against a reference EMI fingerprint for the target asset to determine whether the target asset contains unwanted electronic components (step 208).

FIG. 3 presents a flow chart illustrating a process for generating a target EMI fingerprint from target EMI signals in accordance with the disclosed embodiments. (This flow chart illustrates in more detail the operations performed in step 206 of the flow chart in FIG. 2.) While generating the target EMI fingerprint from the target EMI signals, the system performs a target FFT operation on the target EMI signals to transform the target EMI signals from a time-domain representation to a frequency-domain representation (step 302). Next, the system partitions an output of the target FFT operation into a set of frequency bins (step 304). The system then constructs a target amplitude time-series signal for each of the frequency bins in the set of frequency bins (step 306), and selects a subset of frequency bins that are associated with the highest average correlation coefficients (step 308). Finally, the system generates the target EMI fingerprint by combining target amplitude time-series signals for each of the selected subset of frequency bins (step 310).

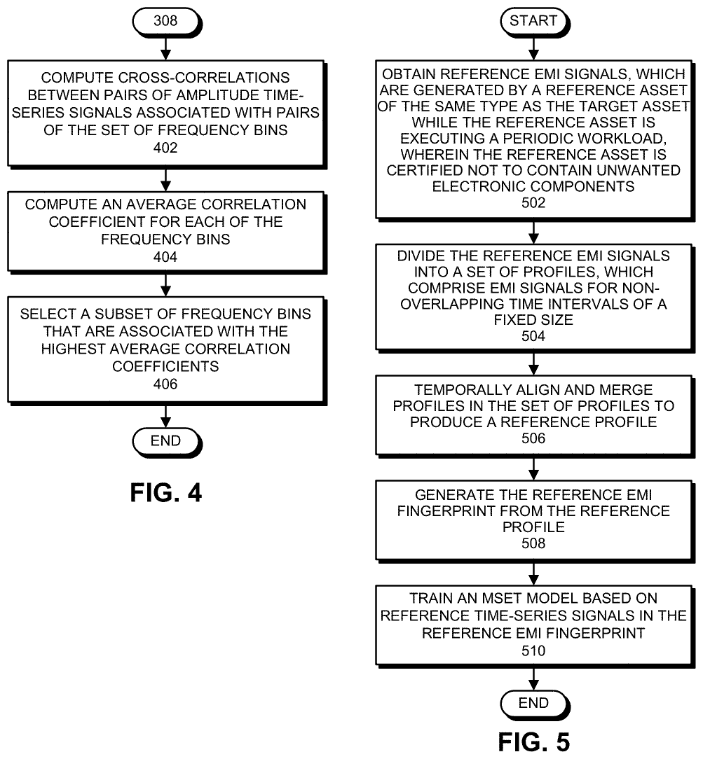

FIG. 4 presents a flow chart illustrating a process for selecting a subset of frequency bins with the highest correlation coefficients in accordance with the disclosed embodiments. (This flow chart illustrates in more detail the operations performed in step 308 of the flow chart in FIG. 3.) The system first computes cross-correlations between pairs of amplitude time-series signals associated with pairs of the set of frequency bins (step 402). Next, the system computes an average correlation coefficient for each of the frequency bins (step 404). Finally, the system selects a subset of frequency bins that are associated with the highest average correlation coefficients (step 406).

FIG. 5 presents a flow chart illustrating a process for generating a reference EMI fingerprint in accordance with the disclosed embodiments. During this process, the system obtains reference EMI signals, which are generated by a reference asset of the same type as the target asset while the reference asset is executing a periodic workload, wherein the reference asset is certified not to contain unwanted electronic components (step 502). Next, system divides the reference EMI signals into a set of profiles, which comprise EMI signals for non-overlapping time intervals of a fixed size (step 504). The system then temporally aligns and merges profiles in the set of profiles to produce a reference profile (step 506). Next, the system generates the reference EMI fingerprint from the reference profile (step 508). Finally, the system trains an MSET model based on reference time-series signals in the reference EMI fingerprint (step 510).

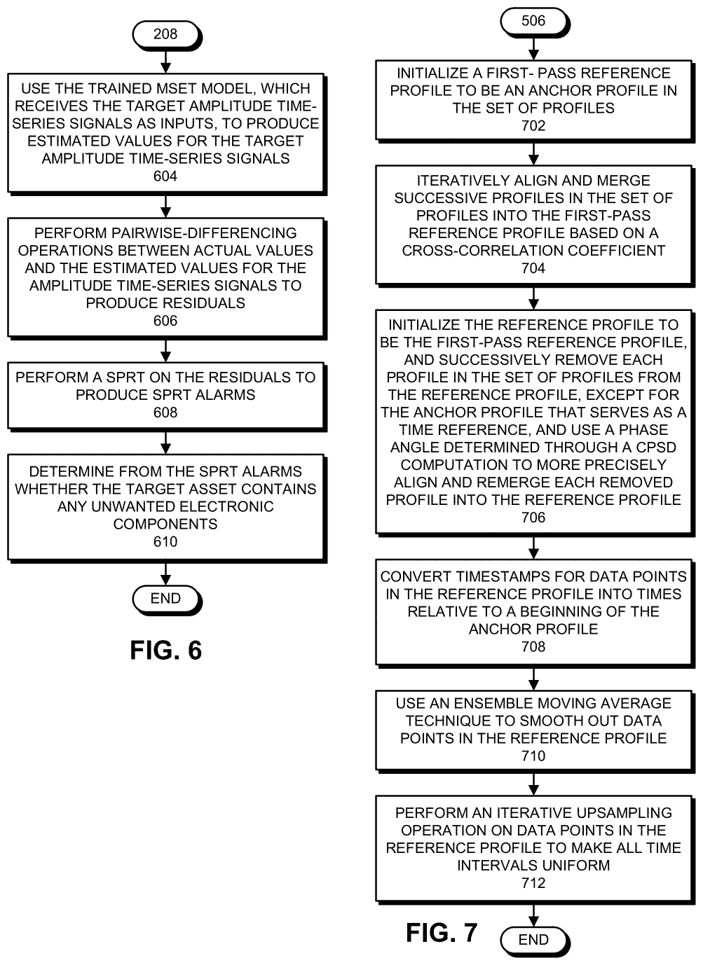

FIG. 6 presents a flow chart illustrating a process for comparing a target EMI fingerprint with a reference EMI fingerprint in accordance with the disclosed embodiments. (This flow chart illustrates in more detail the operations performed in step 208 of the flow chart in FIG. 2.) First, the system uses the trained MSET model (from step 508 above), which receives the target amplitude time-series signals as inputs, to produce estimated values for the target amplitude time-series signals (step 604). The system then performs pairwise-differencing operations between actual values and the estimated values for the amplitude time-series signals to produce residuals (step 606). Next, the system performs a SPRT on the residuals to produce SPRT alarms (step 608). Finally, the system determines from the SPRT alarms whether the target computing system contains any unwanted electronic components (step 610).

FIG. 7 presents a flow chart illustrating a process for temporally aligning and merging profiles to produce the reference profile in accordance with the disclosed embodiments. (This flow chart illustrates in more detail the operations performed in step 506 of the flow chart in FIG. 5.) The system first initializes a first-pass reference profile to be an anchor profile in the set of profiles (step 702). Next, the system iteratively aligns and merges successive profiles in the set of profiles into the first-pass reference profile based on a cross-correlation coefficient (step 704). Then, the system further refines the first-pass reference profile to produce the reference profile. During, this process, the system initializes the reference profile to be the first-pass reference profile, and successively removes each profile in the set of profiles from the reference profile, except for the reference profile that serves as a time reference, and uses a phase angle determined through a CPSD computation to more precisely align and remerge each removed profile into the reference profile (step 706). The system then further refines the data points in the reference profile. During this process, the system converts timestamps for data points in the reference profile into times relative to a beginning of the anchor profile (step 708). Next, the system uses an ensemble moving average technique to smooth out data points in the reference profile (step 710). Finally, the system performs an iterative upsampling operation on data points in the reference profile to make all time intervals uniform (step 712).

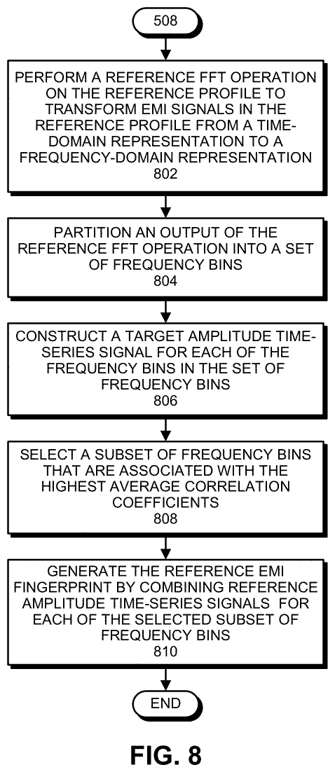

FIG. 8 presents a flow chart illustrating a process for generating a reference EMI fingerprint for a reference profile in accordance with the disclosed embodiments. (This flow chart illustrates in more detail the operations performed in step 508 of the flow chart in FIG. 5.) The system first performs a reference FFT operation on the reference profile to transform EMI signals in the reference profile from a time-domain representation to a frequency-domain representation (step 802). Next, the system partitions an output of the reference FFT operation into a set of frequency bins (step 804). The system then constructs a reference amplitude time-series signal for each of the frequency bins in the set of frequency bins (step 806), and selects a subset of frequency bins that are associated with the highest average correlation coefficients (step 808). Finally, the system generates the reference EMI fingerprint by combining target amplitude time-series signals for each of the selected subset of frequency bins (step 810).

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for generating a reference EMI fingerprint to be used in detecting unwanted electronic components in a target asset, the method comprising:
gathering reference EMI signals generated by a reference asset while the reference asset is executing a periodic workload, wherein the reference asset is of the same type as the target asset and is certified not to contain unwanted electronic components;
dividing the reference EMI signals into a set of profiles, which comprise EMI signals for non-overlapping time intervals of a fixed size;
temporally aligning and merging profiles in the set of profiles to produce a reference profile;
generating the reference EMI fingerprint from the reference profile; and
comparing a target EMI fingerprint for the target asset against the reference EMI fingerprint to determine whether the target asset contains unwanted electronic components.

2. The method of claim 1, wherein temporally aligning and merging the profiles in the set of profiles to produce the reference profile involves:
constructing a first-pass reference profile by,
initializing the first-pass reference profile to be an anchor profile in the set of profiles, and
iteratively aligning and merging successive profiles in the set of profiles into the first-pass reference profile based on a cross-correlation coefficient; and
further refining the first-pass reference profile to produce the reference profile by,
initializing the reference profile to be the first-pass reference profile, and
successively removing each profile in the set of profiles from the reference profile, except for the anchor profile that serves as an immutable time reference, and using a phase angle determined through a CPSD computation to more precisely align and remerge each removed profile into the reference profile.

3. The method of claim 2, wherein producing the reference profile further comprises refining the reference profile by:
converting timestamps for data points in the reference profile into times relative to a beginning of the anchor profile;
using an ensemble moving average technique to smooth out data points in the reference profile; and
performing an iterative upsampling operation on data points in the reference profile to make all time intervals uniform.

4. The method of claim 1, wherein generating the reference EMI fingerprint from the reference profile involves:
performing a reference Fast Fourier Transform (FFT) operation on the reference profile to transform EMI signals in the reference profile from a time-domain representation to a frequency-domain representation;
partitioning an output of the reference FFT operation into a set of frequency bins;
constructing a reference amplitude time-series signal for each of the frequency bins in the set of frequency bins;
selecting a subset of frequency bins that are associated with the highest average correlation coefficients; and
generating the reference EMI fingerprint by combining target amplitude time-series signals for each of the selected subset of frequency bins.

5. The method of claim 4, wherein selecting the subset of frequency bins involves:
computing cross-correlations between pairs of amplitude time-series signals associated with pairs of the set of frequency bins;
computing an average correlation coefficient for each of the frequency bins; and
selecting a subset of frequency bins that are associated with the highest average correlation coefficients.

6. The method of claim 1, wherein prior to comparing the target EMI fingerprint against the reference EMI fingerprint, the method comprises generating the target EMI fingerprint by:
obtaining the target EMI signals by monitoring EMI signals generated by the target asset while the target asset is executing the periodic workload; and
generating the target EMI fingerprint from the target EMI signals.

7. The method of claim 6, wherein generating the reference EMI fingerprint additionally involves training a multivariate state estimation technique (MSET) model based on reference time-series signals in the reference EMI fingerprint.

8. The method of claim 7, wherein comparing the target EMI fingerprint against the reference EMI fingerprint involves:
feeding target time-series signals from the target EMI fingerprint into the trained MSET model to produce estimated values for the target time-series signals;
performing pairwise-differencing operations between actual values and the estimated values for the target time-series signals to produce residuals;
performing a sequential probability ratio test (SPRT) on the residuals to produce SPRT alarms; and
determining from the SPRT alarms whether the target asset contains unwanted electronic components.

9. The method of claim 1, wherein the periodic workload comprises a sinusoidal workload.

10. A non-transitory, computer-readable storage medium storing instructions that when executed by a computer cause the computer to perform a method for generating a reference EMI fingerprint to be used in detecting unwanted electronic components in a target asset, the method comprising:
gathering reference EMI signals generated by a reference asset while the reference asset is executing a periodic workload, wherein the reference asset is of the same type as the target asset and is certified not to contain unwanted electronic components;
dividing the reference EMI signals into a set of profiles, which comprise EMI signals for non-overlapping time intervals of a fixed size;
temporally aligning and merging profiles in the set of profiles to produce a reference profile;
generating the reference EMI fingerprint from the reference profile; and
comparing a target EMI fingerprint for the target asset against the reference EMI fingerprint to determine whether the target asset contains unwanted electronic components.

11. The non-transitory, computer-readable storage medium of claim 10, wherein temporally aligning and merging the profiles in the set of profiles to produce the reference profile involves:
constructing a first-pass reference profile by,
initializing the first-pass reference profile to be an anchor profile in the set of profiles, and
iteratively aligning and merging successive profiles in the set of profiles into the first-pass reference profile based on a cross-correlation coefficient; and
further refining the first-pass reference profile to produce the reference profile by,
initializing the reference profile to be first-pass reference profile, and
successively removing each profile in the set of profiles from the reference profile, except for the anchor profile that serves as an immutable time reference, and using a phase angle determined through a CPSD computation to more precisely align and remerge each removed profile into the reference profile.

12. The non-transitory, computer-readable storage medium of claim 11, wherein producing the reference profile further comprises refining the reference profile by:
converting timestamps for data points in the reference profile into times relative to a beginning of the anchor profile;
using an ensemble moving average technique to smooth out data points in the reference profile; and
performing an iterative upsampling operation on data points in the reference profile to make all time intervals uniform.

13. The non-transitory, computer-readable storage medium of claim 10, wherein generating the reference EMI fingerprint from the reference profile involves:
performing a reference FFT operation on the reference profile to transform EMI signals in the reference profile from a time-domain representation to a frequency-domain representation;
partitioning an output of the reference FFT operation into a set of frequency bins;
constructing a reference amplitude time-series signal for each of the frequency bins in the set of frequency bins;
selecting a subset of frequency bins that are associated with the highest average correlation coefficients; and
generating the reference EMI fingerprint by combining target amplitude time-series signals for each of the selected subset of frequency bins.

14. The non-transitory, computer-readable storage medium of claim 13, wherein selecting the subset of frequency bins involves:
computing cross-correlations between pairs of amplitude time-series signals associated with pairs of the set of frequency bins;
computing an average correlation coefficient for each of the frequency bins; and
selecting a subset of frequency bins that are associated with the highest average correlation coefficients.

15. The non-transitory, computer-readable storage medium of claim 10, wherein prior to comparing the target EMI fingerprint against the reference EMI fingerprint, the method comprises generating the target EMI fingerprint by:
obtaining the target EMI signals by monitoring EMI signals generated by the target asset while the target asset is executing the periodic workload; and
generating the target EMI fingerprint from the target EMI signals.

16. The non-transitory, computer-readable storage medium of claim 15, wherein generating the reference EMI fingerprint additionally involves training an MSET model based on reference time-series signals in the reference EMI fingerprint.

17. The non-transitory, computer-readable storage medium of claim 16, wherein comparing the target EMI fingerprint against the reference EMI fingerprint involves:
feeding target time-series signals from the target EMI fingerprint into the trained MSET model to produce estimated values for the target time-series signals;
performing pairwise-differencing operations between actual values and the estimated values for the target time-series signals to produce residuals;
performing a sequential probability ratio test (SPRT) on the residuals to produce SPRT alarms; and
determining from the SPRT alarms whether the target asset contains unwanted electronic components.

18. The non-transitory, computer-readable storage medium of claim 10, wherein the periodic workload comprises a sinusoidal workload.

19. A system that generates a reference EMI fingerprint and uses the reference EMI fingerprint to detect unwanted electronic components in a target asset, comprising:
at least one processor and at least one associated memory; and
a detection mechanism that executes on the at least one processor, wherein the detection mechanism:
gathers reference EMI signals generated by a reference asset while the reference asset is executing a periodic workload, wherein the reference asset is of the same type as the target asset and is certified not to contain unwanted electronic components;
divides the reference EMI signals into a set of profiles, which comprise EMI signals for non-overlapping time intervals of a fixed size;
temporally aligns and merges profiles in the set of profiles to produce a reference profile;
generates the reference EMI fingerprint from the reference profile; and
compares a target EMI fingerprint for the target asset against the reference EMI fingerprint to determine whether the target asset contains unwanted electronic components.

20. The system of claim 19, wherein while temporally aligning and merging the profiles in the set of profiles to produce the reference profile, the detection mechanism:
constructs a first-pass reference profile by,
initializing the first-pass reference profile to be an anchor profile in the set of profiles, and
iteratively aligning and merging successive profiles in the set of profiles into the first-pass reference profile based on a cross-correlation coefficient; and
further refines the first-pass reference profile to produce the reference profile by,
initializing the reference profile to be the first-pass reference profile, and
successively removing each profile in the set of profiles from the reference profile, except for the anchor profile that serves as a time reference and
using a phase angle determined through a CPSD computation to more precisely align and remerge each removed profile into the reference profile.
